(19) United States
(12) Patent Application Publication
(10) Pub. No.: US 2024/0308327 A1
(43) Pub. Date: Sep. 19, 2024

(54) DRIVING SYSTEM AND AUTOMATIC GUIDED VEHICLE

(71) Applicant: ABB SCHWEIZ AG, Baden (CH)

(72) Inventor: Zhijun Ding, Shanghai (CN)

(21) Appl. No.: 18/670,553

(22) Filed: May 21, 2024

Related U.S. Application Data
(63) Continuation of application No. PCT/CN2021/134099, filed on Nov. 29, 2021.

(51) Int. Cl. B60K 7/00; H02K 7/106

(52) U.S. Cl. CPC B60K 7/0007; H02K 7/106; B60K 2007/0038; B60K 2007/0092

(57) ABSTRACT

Embodiments of present disclosure relate to a driving system and an automatic guided vehicle. The driving system includes a hub motor; a braking assembly coupled to the hub motor and configured to allow or stop rotation of the hub motor; and a suspension assembly coupled to the hub motor and adapted to be mounted on a chassis of the automatic guided vehicle. The suspension assembly is configured to allow the hub motor to move upwards or downwards with respect to the chassis.

### FIELD

Embodiments of the present disclosure generally relate to the field of automated guided vehicle.

### BACKGROUND

An Automatic Guided Vehicle (AGV) is an unmanned and/or self-propelled vehicle for transporting payloads along a route without real-time human assistance. The AGV may operate under controlled navigation. For example, it typically moves along a guided path or route disposed in or on a facility floor, a warehouse, a distribution center, etc. Traditional automatic guided vehicles may have a driving system selected from a steering wheel drive system, a mecanum wheel drive system, and a mechanism having a motor, a gear and a wheel. Each of the above driving systems is heavy, complicated or occupies a large space. Further, when the floor is not flat, one or more wheels of the automatic guided vehicle may suspend in midair, such that the automatic guided vehicle goes away from the guided path or route, or gets stuck. Thus, a suspension mechanism is needed. However, traditional suspension mechanisms suitable for the above driving systems are complicated and are fully received within the automatic guided vehicle. It is inconvenient for a user to adjust the stiffness of the suspension mechanism.

Therefore, there is a need in the art for an improved automatic guided vehicle.

### SUMMARY

In view of the foregoing problems, example embodiments of the present disclosure propose an automatic guided vehicle that has a simple structure and a low cost and the stiffness of the suspension mechanism is easy to be adjusted.

In a first aspect of the present disclosure, a driving system for use in an automatic guided vehicle is provided. The driving system comprises: a hub motor; a braking assembly coupled to the hub motor and configured to allow or stop rotation of the hub motor; and a suspension assembly coupled to the hub motor and adapted to be mounted on a chassis of the automatic guided vehicle, wherein the suspension assembly is configured to allow the hub motor to move upwards or downwards with respect to the chassis.

With these embodiments, the automatic guided vehicle may be equipped with a hub motor as a part of its driving system. The structure of the automatic guided vehicle is simplified, and the cost of the automatic guided vehicle is reduced. Besides, due to the design of the suspension assembly, the automatic guided vehicle can move across obstacles or pits on the floor.

In some embodiments, the braking assembly comprises: a rotating member attached to the hub motor; a base member coupled to a mounting shaft of the hub motor; and an electromagnetic brake attached to the base member and configured to engage or disengage the rotating member to allow or stop the rotation of the hub motor. With these embodiments, the braking assembly may be implemented in a simple structure, such that the cost of the automatic guided vehicle is reduced. Besides, the hub motor may be stopped reliably by means of the braking assembly.

In some embodiments, the driving system further comprises an adapting flange coupled between the rotating member and the hub motor. The adapting flange is designed to be mounted on an end cover of the hub motor and acts as a connecting member between the rotating member and the hub motor together.

In some embodiments, the suspension assembly comprises: a suspension arm having a first end coupled to a mounting shaft of the hub motor and a second end opposite to the first end; an elastic member adapted to be coupled between the chassis of the automatic guided vehicle and the second end of the suspension arm; and a pivot shaft pivotally supporting a middle portion of the suspension arm between the first end and the second end. The suspension arm can pivot around the pivot shaft, such that the first end can move upwards or downwards with respect to the chassis. In this way, the hub motor can move upwards or downwards with respect to the chassis, thereby the automatic guided vehicle can move across the obstacles or pits. Besides, the structure of the suspension assembly having the suspension arm is very simple and has low weight.

In some embodiments, the suspension assembly further comprises: a support adapted to be arranged on the chassis of the automatic guided vehicle, wherein the pivot shaft is attached to the support; and a first stopper and a second stopper arranged on opposite sides of the support. With these embodiments, the hub motor can move upwards or downwards with respect to the chassis, and the rotating angle of the suspension arm is limited by the first stopper and the second stopper.

In some embodiments, the suspension assembly further comprises: a nut adapted to be attached to the chassis of the automatic guided vehicle; and a sleeve coupled to the nut through threads and accommodating a portion of the elastic member. In this way, the stiffness of the suspension mechanism is easy to be adjusted through rotating the sleeve.

In a second aspect of the present disclosure, an automatic guided vehicle is provided. The automatic guided vehicle comprises: a chassis; and a driving system, the driving system comprising: a hub motor; a braking assembly coupled to the hub motor and configured to allow or stop rotation of the hub motor; and a suspension assembly mounted on the chassis and coupled to the hub motor, wherein the suspension assembly is configured to allow the hub motor to move upwards or downwards with respect to the chassis.

With these embodiments, the automatic guided vehicle is equipped with a hub motor as a part of its driving system. The structure of the automatic guided vehicle is simplified, and the cost of the automatic guided vehicle is reduced. Besides, due to the design of the suspension assembly, the automatic guided vehicle can move across obstacles or pits on the floor.

In some embodiments, the braking assembly comprises: a rotating member attached to the hub motor; a base member coupled to a mounting shaft of the hub motor; and an electromagnetic brake attached to the base member and configured to engage or disengage the rotating member to allow or stop the rotation of the hub motor. With these embodiments, the braking assembly may be implemented in a simple structure, such that the cost of the automatic guided vehicle is reduced. Besides, the hub motor may be stopped reliably by means of the braking assembly.

In some embodiments, the driving system further comprises an adapting flange coupled between the rotating member and the hub motor. The adapting flange is designed to be mounted on an end cover of the hub motor and acts as a connecting member between the rotating member and the hub motor together.

In some embodiments, the suspension assembly comprises: a suspension arm having a first end coupled to a mounting shaft of the hub motor and a second end opposite to the first end; an elastic member coupled between the chassis and the second end of the suspension arm; and a pivot shaft pivotally supporting a middle portion of the suspension arm between the first end and the second end. The suspension arm can pivot around the pivot shaft, such that the hub motor can move upwards or downwards with respect to the chassis, thereby the automatic guided vehicle can move across the obstacles or pits. Besides, the structure of the suspension assembly having the suspension arm is very simple and has low weight.

In some embodiments, the suspension assembly further comprises: a support arranged on the chassis of the automatic guided vehicle, wherein the pivot shaft is attached to the support; and a first stopper and a second stopper arranged on opposite sides of the support. With these embodiments, the hub motor can move upwards or downwards with respect to the chassis, and the rotating angle of the suspension arm is limited by the first stopper and the second stopper.

In some embodiments, the suspension assembly further comprises: a nut attached to the chassis; and a sleeve coupled to the nut through threads and accommodating a portion of the elastic member. In this way, the stiffness of the suspension mechanism is easy to be adjusted through rotating the sleeve.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 schematically illustrates a perspective view of a driving system of an automatic guided vehicle according to some embodiments of the present disclosure;

FIG. 2 schematically illustrates a side view of the driving system of FIG. 1, wherein a chassis of the automatic guided vehicle is shown in dashed line;

FIG. 3 schematically illustrates an exploded perspective view of the driving system of FIG. 1;

FIG. 4 schematically illustrates a cross-sectional view of the driving system of FIG. 2 taken along line A-A; and

FIG. 5 schematically illustrates a top view of an automatic guided vehicle according to some embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As described above, traditional suspension mechanisms suitable for the above driving systems are complicated and are fully received within the automatic guided vehicle. Therefore, there is a need in the art for an improved automatic guided vehicle.

An automatic guided vehicle (AGV) may move along a guided path or route disposed in or on the facility floor. The automatic guided vehicle may comprise a chassis and two driving systems respectively arranged on two opposite sides of the chassis. When the automatic guided vehicle needs to move forward or backward, the two driving systems may be operated at the same speed. When the automatic guided vehicle needs to turn a corner, the two driving systems may be operated at different speeds.

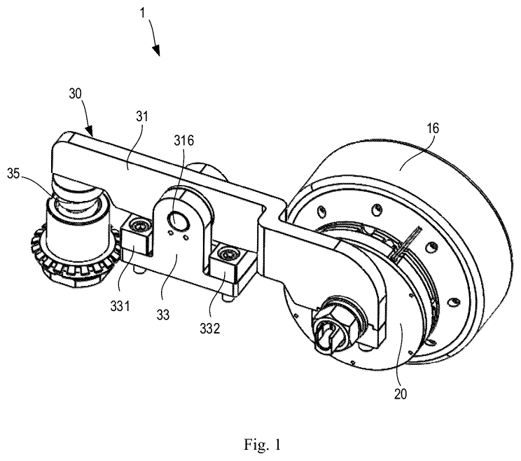

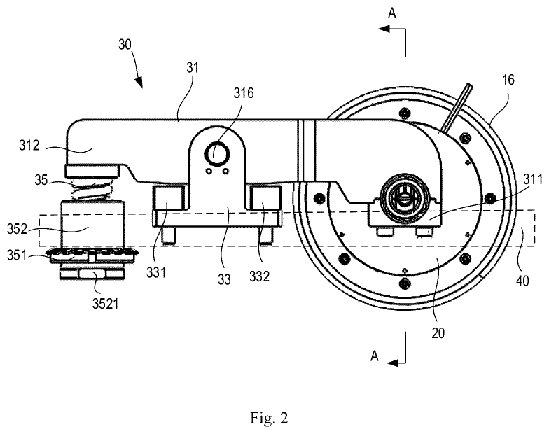

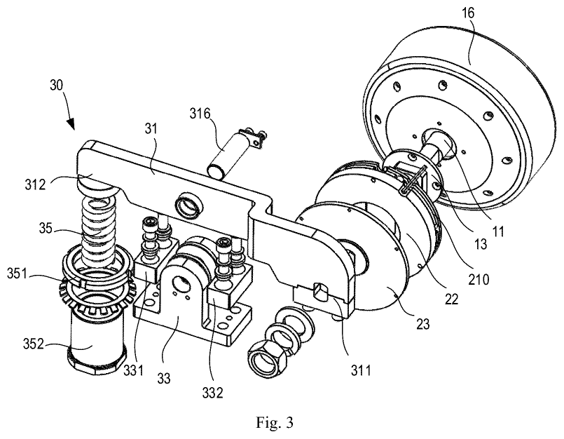

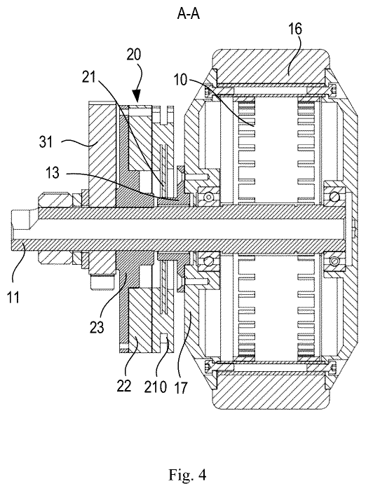

In the following, example constructions and operating principles of the driving system will be described with reference to FIGS. 1-4. FIG. 1 schematically illustrates a perspective view of a driving system of an automatic guided vehicle according to some embodiments of the present disclosure. FIG. 2 schematically illustrates a side view of the driving system of FIG. 1, wherein a chassis of the automatic guided vehicle is shown in dashed line. FIG. 3 schematically illustrates an exploded perspective view of the driving system of FIG. 1. FIG. 4 schematically illustrates a cross-sectional view of the driving system of FIG. 2 taken along line A-A.

As shown in FIGS. 1-4, the driving system 1 comprises a hub motor 10, a braking assembly 20 and a suspension assembly 30. With the hub motor 10, the weight of the driving system 1 is reduced, and the structure of the driving system 1 is simplified, thereby the cost of the driving system 1 is reduced.

As the hub motor 10 is arranged on the automatic guided vehicle, the braking assembly 20 may be used to stop the automatic guided vehicle when the automatic guided vehicle is in a standby state or deactivated by an emergency stop command. The braking assembly 20 is coupled to the hub motor 10 and configured to allow or stop rotation of the hub motor 10. In some embodiments, the hub motor 10 is an external rotor hub motor. For example, A tyre 16 may be attached to the external rotor of the hub motor 10. Alternatively, the external rotor of the hub motor 10 may be formed as a wheel of the automatic guided vehicle.

In some embodiments, the hub motor 10 may comprise a mounting shaft 11. The external rotor can rotate around the mounting shaft 11.

For the purpose of moving across the obstacles or pits, the suspension assembly 30 is coupled to the hub motor 10 and can be mounted on the chassis of the automatic guided vehicle. In this way, the suspension assembly 30 can allow the hub motor 10 to move upwards or downwards with respect to the chassis. As such, the automatic guided vehicle can move across the obstacles or pits when the floor is not flat.

In some embodiments, as shown in FIGS. 1-3, the suspension assembly 30 may comprise a suspension arm 31, an elastic member 35, and a pivot shaft 316.

The suspension arm 31 has a first end 311 and a second end 312 opposite to the first end 311. The first end 311 is coupled to the mounting shaft 11 of the hub motor 10. The elastic member 35 is adapted to be coupled between the chassis 40 (shown in FIG. 2) of the automatic guided vehicle and the second end 312 of the suspension arm 31. The pivot shaft 316 pivotally supports a middle portion of the suspension arm 31 between the first end 311 and the second end 312. In this way, the suspension arm 31 may pivot around the pivot shaft 316, and thus the hub motor 10 can move upwards or downwards with respect to the chassis 40.

In some embodiments, the elastic member 35 may be a coil spring. In other embodiments, the elastic member 35 may be of other types. The scope of the present disclosure is not intended to be limited in this respect.

In some embodiments, the suspension assembly 30 may further comprise a support 33, a first stopper 331 and a second stopper 332. The support 33 is adapted to be arranged on the chassis 40 of the automatic guided vehicle. The pivot shaft 316 is attached to the support 33. As such, the suspension arm 31 is supported by the pivot 316 and the support 33.

The first stopper 331 and the second stopper 332 are arranged on opposite sides of the support 33. As such, the rotating angle of the suspension arm 31 is limited by the first stopper 331 and the second stopper 332.

As shown in FIG. 2, the suspension assembly 30 may further comprise a nut 351 and a sleeve 352. The nut 351 is adapted to be fixedly attached to the chassis 40 of the automatic guided vehicle. The sleeve 352 is coupled to the nut 351 through threads. A portion of the elastic member 35 is accommodated by or received within the sleeve 352. In other words, the portion of the elastic member 35 is received in the sleeve 352. With these embodiments, the sleeve 352 can be adjusted or rotated with respect to the nut 351.

In this way, the distance between the sleeve 352 and the second end 312 of the suspension arm 31 is changed. Thus, the compression force applied onto the elastic member 35 can be adjusted and thus the stiffness of the suspension assembly 30 is adjusted.

In some embodiments, the sleeve 352 may have a head 3521 that can be rotated by a user to adjust the stiffness of the suspension assembly 30. The head 3521 may be arranged on a side of the chassis of 40 facing the floor, such that the user can adjust the stiffness of the suspension assembly 30 on site without disassembling the automatic guided vehicle.

In some embodiments, as shown in FIGS. 3-4, the braking assembly 20 may comprise a rotating member 21, a base member 23 and an electromagnetic brake 22. The rotating member 21 is attached to the hub motor 10. In some embodiments, the rotating member 21 can be attached to the hub motor 10 by an adapting flange 13. For example, the adapting flange 13 may be attached to an end cover 17 of the hub motor 10 as shown in FIG. 4. In some embodiments, the rotating member 21 may be a friction disc and received within a housing 210.

As shown in FIGS. 3-4, the base member 23 may be coupled to the mounting shaft 11 of the hub motor 10. The electromagnetic brake 22 is attached to the base member 23. In these embodiments, the electromagnetic brake 22 can allow or stop the rotation of the rotating member 21.

In some embodiments, when the electromagnetic brake 22 is activated, the electromagnetic brake 22 may be forced away from the rotating member 21 to allow the rotation of the hub motor 10. If the electromagnetic brake 22 is deactivated, the electromagnetic brake 22 may engage the rotating member 21 to stop the rotation of the hub motor 10.

In other embodiments, when the electromagnetic brake 22 is deactivated, the electromagnetic brake 22 may be kept away from the rotating member 21 to allow the rotation of the hub motor 10. If the electromagnetic brake 22 is activated, the electromagnetic brake 22 may engage the rotating member 21 to stop the rotation of the hub motor 10.

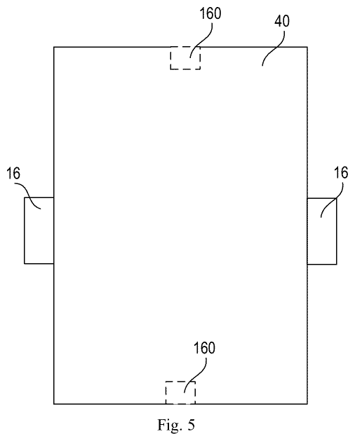

According to some embodiments of present disclosure, an automatic guided vehicle is provided. FIG. 5 schematically illustrates a top view of an automatic guided vehicle according to some embodiments of the present disclosure.

The automatic guided vehicle comprises a chassis 40 and the driving system as discussed above. Specifically, the driving system comprises a hub motor 10, a braking assembly 20 and a suspension assembly 30. The braking assembly 20 is coupled to the hub motor 10. The suspension assembly 30 is mounted on the chassis 40 and is coupled to the hub motor 10.

In some embodiments, the braking assembly 20 comprises a rotating member 21, a base member 23 and an electromagnetic brake 22. The rotating member 21 is attached to the hub motor 10. The base member 23 is coupled to a mounting shaft 11 of the hub motor 10. The electromagnetic brake 22 is attached to the base member 23 and thus can engage or disengage the rotating member 21 to allow or stop the rotation of the hub motor 10.

In some embodiments, the driving system may further comprise an adapting flange 13. The adapting flange 13 is coupled between the rotating member 21 and the hub motor 10.

In some embodiments, the suspension assembly 30 may comprise a suspension arm 31, an elastic member 35 and a pivot shaft 316. The suspension arm 31 has a first end 311 coupled to a mounting shaft 11 of the hub motor 10 and a second end 312 opposite to the first end 311. The elastic member 35 is coupled between the chassis 40 and the second end 312 of the suspension arm 31. The pivot shaft 316 pivotally supports a middle portion of the suspension arm 31 between the first end 311 and the second end 312.

In some embodiments, the suspension assembly 30 may further comprise: a support 33, a first stopper 331 and a second stopper 332. The support 33 is arranged on the chassis 40 of the automatic guided vehicle, and the pivot shaft 316 is attached to the support 33. The first stopper 331 and the second stopper 332 are arranged on opposite sides of the support 33.

In some embodiments, the suspension assembly 30 may further comprise a nut 351 and a sleeve 352. The nut 351 is attached to the chassis 40; and the sleeve 352 is coupled to the nut 351 through threads and accommodates a portion of the elastic member 35.

In some embodiments, the automatic guided vehicle may comprise two driving systems arranged on two opposite sided of the chassis 40. For the purpose of keeping the balance of the chassis 40, one or more unpowered universal wheel 160 may be mounted on the chassis 40.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A driving system for use in an automatic guided vehicle, comprising:
a hub motor;
a braking assembly coupled to the hub motor and configured to allow or stop rotation of the hub motor; and
a suspension assembly coupled to the hub motor and adapted to be mounted on a chassis of the automatic guided vehicle, wherein the suspension assembly is configured to allow the hub motor to move upwards or downwards with respect to the chassis.

2. The driving system of claim 1, wherein the braking assembly comprises:
a rotating member attached to the hub motor;
a base member coupled to a mounting shaft of the hub motor; and
an electromagnetic brake attached to the base member and configured to engage or disengage the rotating member to allow or stop the rotation of the hub motor.

3. The driving system of claim 2, further comprising an adapting flange coupled between the rotating member and the hub motor.

4. The driving system of claim 1, wherein the suspension assembly comprises:
a suspension arm having a first end coupled to a mounting shaft of the hub motor and a second end opposite to the first end;
an elastic member adapted to be coupled between the chassis of the automatic guided vehicle and the second end of the suspension arm; and
a pivot shaft pivotally supporting a middle portion of the suspension arm between the first end and the second end.

5. The driving system of claim 4, wherein the suspension assembly further comprises:
a support adapted to be arranged on the chassis of the automatic guided vehicle, wherein the pivot shaft is attached to the support; and
a first stopper and a second stopper arranged on opposite sides of the support.

6. The driving system of claim 4, wherein the suspension assembly further comprises:
a nut adapted to be attached to the chassis of the automatic guided vehicle; and
a sleeve coupled to the nut through threads and accommodating a portion of the elastic member.

7. An automatic guided vehicle, comprising:
a chassis; and
a driving system, the driving system comprising:
a hub motor;
a braking assembly coupled to the hub motor and configured to allow or stop rotation of the hub motor; and
a suspension assembly mounted on the chassis and coupled to the hub motor, wherein the suspension assembly is configured to allow the hub motor to move upwards or downwards with respect to the chassis.

8. The automatic guided vehicle of claim 7, wherein the braking assembly comprises:
a rotating member attached to the hub motor;
a base member coupled to a mounting shaft of the hub motor; and
an electromagnetic brake attached to the base member and configured to engage or disengage the rotating member to allow or stop the rotation of the hub motor.

9. The automatic guided vehicle of claim 8, wherein the driving system further comprises an adapting flange coupled between the rotating member and the hub motor.

10. The automatic guided vehicle of claim 7, wherein the suspension assembly comprises:
a suspension arm having a first end coupled to a mounting shaft of the hub motor and a second end opposite to the first end;
an elastic member coupled between the chassis and the second end of the suspension arm; and
a pivot shaft pivotally supporting a middle portion of the suspension arm between the first end and the second end.

11. The automatic guided vehicle of claim 7, wherein the suspension assembly further comprises:
a support arranged on the chassis of the automatic guided vehicle, wherein the pivot shaft is attached to the support; and
a first stopper and a second stopper arranged on opposite sides of the support.

12. The automatic guided vehicle of claim 7, wherein the suspension assembly further comprises:
a nut attached to the chassis; and
a sleeve coupled to the nut through threads and surrounding a portion of the elastic member.
